(19) United States
(12) Patent Application Publication
(10) Pub. No.: US 2006/0053222 A1
(43) Pub. Date: Mar. 9, 2006

(54) Dynamic distribution of files to be processed between terminals

(75) Inventors: Muriel Lauvergne, Trebeurden (FR); Celine Ance, Perros Guirec (FR); Samuel Loyson, Paris (FR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: FRANCE TELECOM, Paris (FR)

(21) Appl. No.: 11/211,540

(22) Filed: Aug. 26, 2005

(30) Foreign Application Priority Data
Sep. 3, 2004 (FR) 0409324

(51) Int. Cl. G06F 15/173

(52) U.S. Cl. 709/226

(57) ABSTRACT

Files to be processed are distributed dynamically and fairly between participant terminals connected to a distribution server in order to minimize the file processing time. The distribution server determines and updates processing speeds of the terminals and an average of the processing speeds in order to adapt the distribution of the files between the participants in real time. The files may be distributed according to the form of processing to be applied to the files and the forms of processing that the terminals can apply.

### RELATED APPLICATIONS

The present application is based on, and claims priority from, French Application Number 0409324, filed Sep. 3, 2004, the disclosure of which is hereby incorporated by reference herein in its entirety.

### BACKGROUND OF THE INVENTION

1. Field of the Invention

The present invention relates to a method of distributing files to be processed between participant terminals connected to a distribution server.

The present invention relates more particularly to the distribution of files in the context of collaborative task of corpus editing between participants.

2. Description of the Prior Art

In the prior art, software for working collaboratively on digital files assists participants in the execution of a collaborative task, such as the annotation of files. That assistance consists primarily in offering the participants task management tools. The management tools do not dynamically share the files to be processed between the participants and do not distribute the files to be processed fairly as a function of the skills of the participants.

### OBJECT OF THE INVENTION

The main object of the invention is to distribute files to be processed dynamically between participant terminals in order to minimize the file processing time.

### SUMMARY OF THE INVENTION

Accordingly, a method of dynamically distributing files to be processed between participants using respective terminals connected to server means includes the following steps in said server means:

in response to a processed file transmitted by a terminal, updating a participant processing speed of each terminal as a function of a processing time of the processed file by the participant of the terminal evaluated from a transmission time of the processed file from the server means to the terminal,

updating an average of the participant processing speeds of the terminals as a function of the updated participant processing speeds of the terminals,

decrementing a number of remaining files to be processed in response to each processed file transmitted by a terminal,

updating a number of files assigned to each terminal as a function of the number of remaining files to be processed, the updated participant processing speed of the terminal and the updated average the participant processing speeds of the terminals, and

transmitting the updated number of assigned files and a remaining file to be processed to each terminal.

Thanks to updating the numbers of files assigned respectively to the terminal participants and still to be processed thereby, the remaining files to be processed are continuously distributed fairly between the participants of the terminals according to the processing speed of each terminal participant, which may vary to a greater or lesser degree, in particular as a function of the instantaneous capacity of the participant at the terminal. The terminals therefore process the files for substantially identical processing times, which minimizes the file processing time. Furthermore, each participant follows on the screen of his terminal the number of files remaining to be processed that are assigned to him. The distribution of the files is therefore continuously adapted to the availability and to the capacities of each participant.

The invention also relates to a system for dynamically distributing files to be processed between participants using respective terminals connected to server means. The system is characterized in that the server means includes:

means for updating, in response to a processed file transmitted by a terminal, a participant processing speed of each terminal as a function of a processing time of the file processed by the participant of the terminal evaluated from the time of transmitting the processed file from the server means to the terminal,

means for updating an average of the participant processing speeds of the terminals as a function of the updated participant processing speeds of the terminals,

means for decrementing a number of remaining files to be processed in response to each processed file transmitted by a terminal,

means for updating a number of files assigned to each terminal as a function of the number of remaining files to be processed, the updated participant processing speed of the terminal and the updated average of the participant processing speeds of the terminals, and

means for transmitting the updated number of assigned files and a file remaining to be processed to each terminal.

### BRIEF DESCRIPTION OF THE DRAWINGS

The foregoing and other objects, features and advantages of the present invention will be apparent from the following detailed description of several embodiments of the invention with reference to the corresponding accompanying drawings, in which:

FIG. 1 is a schematic block diagram of a system for dynamically distributing files to be processed between participant terminals connected to a distribution server using the method of the invention for dynamically distributing files to be processed between the participant terminals;

FIG. 2 is a flow chart of a campaign definition process implemented before using the dynamic file distribution method of the invention; and

FIG. 3 is an flow chart of the method of the invention for dynamically distributing files to be processed between the participant terminals.

### DETAILED DESCRIPTION OF THE DRAWINGS

A corpus is a limited set of elements on which the study of a phenomenon is based. According to the invention, a corpus is a set of digital files to be processed. A campaign defines the task to be carried out on a corpus, i.e. how the files of the corpus are to be processed.

According to the invention, a digital file contains digital data that at least one participant terminal must process. For example, the files comprise text digital data resulting from the transcription of voice signals exchanged between a voice server and a user during a voice service and the processing of the files involves annotating, revising or translating the text files. For example, a first terminal annotates a file, a second terminal revises the annotated file, and a third terminal translates the revised annotated file. In another example, the files comprise digital data of fixed or animated images, the participants are computer graphics specialists and the processing of the files involves retouching the images in the files.

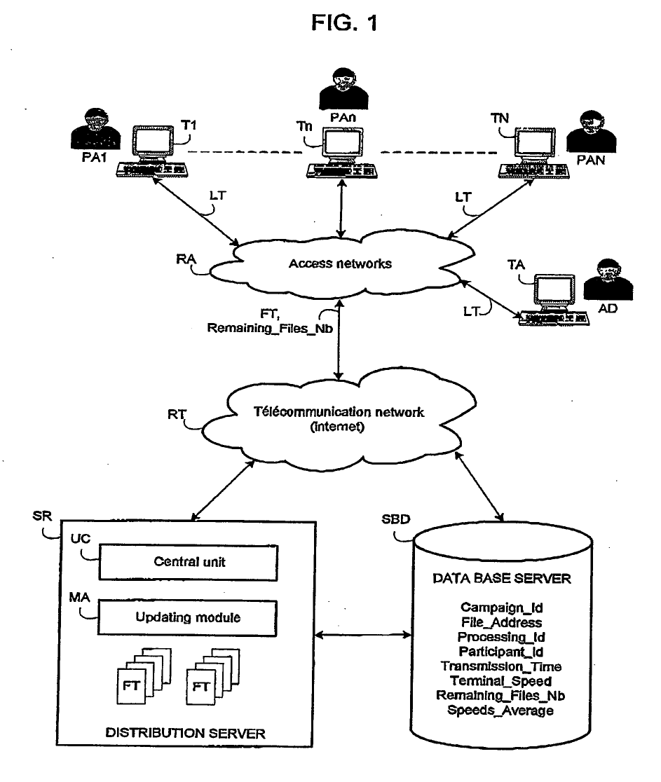

Referring to FIG. 1, the system for dynamically distributing files to be processed between participant terminals using the distribution method of the invention primarily comprises a distribution server SR, a database server SBD, at least one administrator terminal TA, and terminals T1 to TN of participants PA1 to PAN.

FIG. 1 shows three terminals T1, Tn and TN of three participants PA1, PAn and PAN, where 1≦n≦N.

The distribution server SR communicates with the participant terminals via an Internet type telecommunication network RT and respective access networks RA. The database server SBD is connected locally to the distribution server SR, or the distribution server accesses the database server via the telecommunication network RT, or the database server SBD is incorporated into the distribution server SR.

The distribution server SR primarily comprises a central unit UC, an updating module MA and files FT to be processed by the participants.

In one variant, the files FT to be processed are stored on another server, for example the server SBD.

The participant terminal Tn and the administrator terminal TA are connected to the respective access networks RA by links LT.

For example, the terminal Tn or TA is a personal computer connected directly by modem to the link LT, which is of the xDSL (Digital Subscriber Line) line or ISDN (Integrated Services Digital Network) type and connected to the corresponding access network RA. The administrator terminal TA may be connected locally to the distribution server SR.

The terminals T1 to TN of the participants, the terminal TA of the administrator and the access networks RA are not limited to the above example and may comprise other terminals and access networks known in the art. For example, the networks RA and RT may be replaced by a local area network LAN (Local Area Network) or WLAN (Wireless Local Area Network).

In a first phase, the administrator TA defines the campaign with the aid of a software interface. This phase consists in particular of counting the participants and storing the addresses of their terminals, selecting files to be processed, determining how the files are to be processed, etc.

In the remainder of the description, a campaign example is defined in the context of a task of transcribing and annotating a corpus.

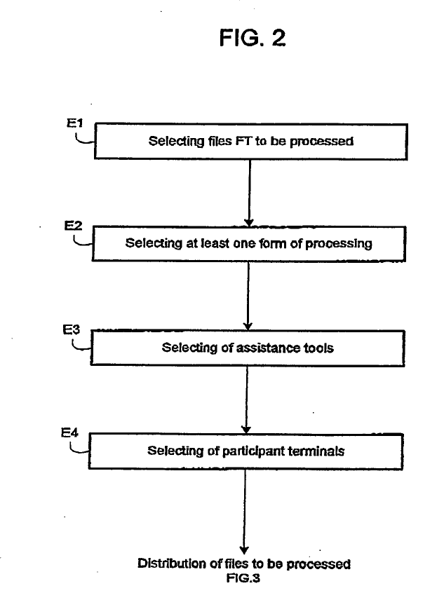

As shown in FIG. 2, the campaign definition process carried out prior to the process according to the invention of dynamically distributing files to be processed between participant terminals essentially comprises steps E1 to E4.

The administrator terminal TA connects to the distribution server SR via the software interface.

In the step E1, the administrator terminal TA selects the files FT of the corpus to be processed according to a file sender address and transmits the selected files to the distribution server SR, which stores them and forwards a list of the addresses of the selected files to the database server SBD, with a campaign identifier. For example, the files FT to be processed come from a particular voice server. The central unit UC of the distribution server SR counts the files to be processed in this campaign and transmits the number thereof to the database server SBD, which stores it.

In the step E2, the administrator terminal TA selects at least one form of processing to be applied to the files FT to be processed and transmits the identifier of the selected form of processing to the distribution server SR, which stores it in the database server SBD in corresponding relationship to the campaign identifier. For example, the files to be processed are associated with two forms of processing, “annotation” and “transcription”. Consequently, the files to be processed are to be annotated and transcribed by the participant terminals.

Where applicable, in the step E3, the administrator terminal TA selects assistance tools for each selected form of processing in order to guarantee the quality and uniformity of the work of the participants. The administrator terminal TA transmits the selected assistance tools to the distribution server, which stores them in the database server SBD in association with the campaign identifier. For example, the administrator terminal TA selects a spellchecker for the transcription processing.

Alternatively, the administrator terminal TA selects assistance tools as a function of the thematic and/or linguistic context of the campaign. For example, for a campaign on files coming from a restaurant location voice service, the administrator terminal TA selects specific tools, such as a spellchecker using a database of terminology specific to restaurants.

In the step E4, the administrator terminal TA also selects beforehand the participant terminals that are to take part in the campaign from a predetermined list of participant identifiers, for example the names of the participants, linked to a list of addresses of the participant terminals. The administrator terminal TA transmits the selected addresses to the distribution server SR, which stores them in the database server SBD in corresponding relationship to the campaign identifier.

From the terminal TA, the administrator can also add participants to the predetermined list or remove participants therefrom.

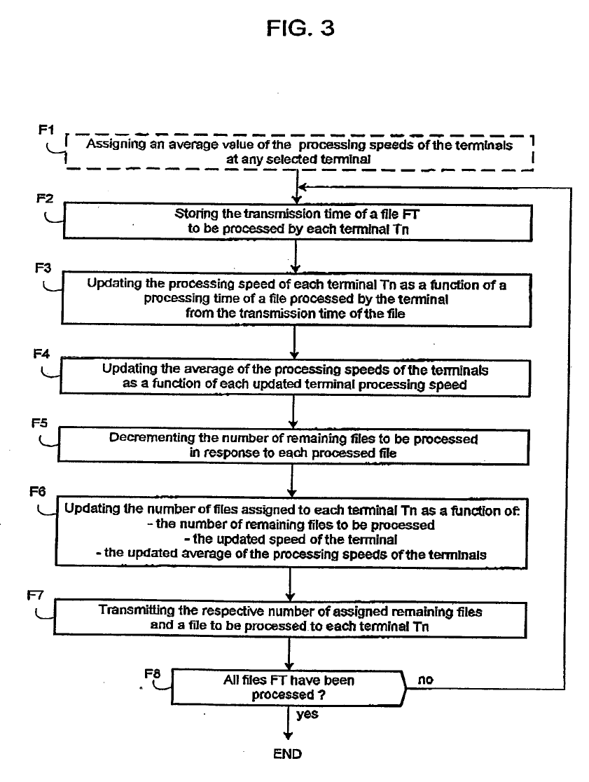

As shown in FIG. 3, the method of the invention for dynamic distribution of files to be processed between participants of terminals in the context of a collaborative task essentially comprises steps F1 to F8.

In a simple embodiment, the campaign is defined by a number of participant terminals and a selection of files FT to be processed, the form of processing to be applied to the files being the same for all the files.

In the step F1, the central unit UC of the distribution server SR initially assigns an average value of the processing speeds of the terminals to any terminal Tn selected in the step E4. Alternatively, the step F1 is eliminated and the processing speeds of the terminals T1 to TN are determined as and when the terminals process the first files in the steps F2 and F3.

In the step F2, the central unit UC transmits transmission times of the files to be processed by the respective terminals to the database server SBD, which stores them in corresponding relationship to the participant identifiers of the terminals. This step is carried out continuously by the distribution server SR each time that the latter transmits a file to be processed to a participant terminal Tn. The file transmission time is stored in the database server SBD as soon as the file FT to be processed has been read and transmitted from the server SR to the terminal Tn under the control of the central unit UC, responsive to the processing of a preceding file, if any, or responsive to a request from the terminal, so that files to be processed are supplied to the terminal Tn almost continuously.

In the step F3, in response to the end of the processing of the file, the updating module MA updates the file processing speed for each terminal Tn as a function of the processing time of the file by the participant of the terminal starting from the transmission time of the stored file. For example, the central unit UC evaluates the processing speed as a function of the number of files processed by the participant of the terminal Tn per unit time, starting from the beginning of the campaign, or as a function of the size in bits of the files processed per unit time. Updating the speed may consist in averaging the processing speed of the terminal Tn stored before processing the file and the processing speed evaluated for the processed file or in retaining only the last evaluated processing speed. In response to each processed file transmitted by a terminal Tn, the central unit UC transmits, with the address of the processed file, the updated file processing speed from the terminal Tn to the database server SBD, which stores it in association with the identifier of the participant PAn of the terminal Tn. This speed updating triggered each time that the participant of the terminal Tn has finished processing a file therefore depends in real time on the availability of the participant of the terminal Tn and of the terminal Tn of the participant PAn, and where applicable on any changes to the processing capacity thereof.

In the step F4, the updating module MA updates the average of the processing speeds of the terminals as a function of the ratio of the sum of the updated processing speeds of the terminals to the number of terminals and therefore of participants. Each time that one of the processing speeds of the terminals is updated, the average of the speeds is updated. This average of the processing speeds is also transmitted to the database server SBD, which stores it.

In the step F5, the central unit UC reads the number of remaining files to be processed in the database server SBD, which it decrements by one in response to each processed file transmitted by a terminal to the server SBD, the number of files remaining being initially equal to the total number of files to be processed at the beginning of the campaign. The decremented number of remaining files is transmitted to the server SBD, which stores it in corresponding relationship to the campaign identifier.

In the step F6, the updating module MA updates the number of files assigned to each terminal Tn as a function of the product of the number of remaining files to be processed and the ratio of the updated processing speed of the terminal Tn and the updated average of the processing speeds of the terminals T1 to TN, so that the processing of the remaining files is distributed dynamically and fairly between the terminals as a function of the instantaneous skills and availabilities of the participants and therefore so that the times for the terminals to process the files are substantially identical. The central unit UC of the server SR transmits the number of files assigned to each terminal Tn to the database server SBD, which stores it in association with the address of the terminal. The server SR preferably also transmits the instantaneous numbers of the files assigned to the participants of the terminals T1 to TN and their updated processing speeds to the server TA for the administrator to monitor continuously the productivity of each participant.

When the distribution server SR assigns a file to a participant terminal it blocks access to that file in write mode from all the other participant terminals.

In the step F7, the central unit UC transmits the respective number of remaining files assigned and a remaining file to be processed to each terminal in response to a request from the terminal. The process is then repeated from the step F2 until all of the files have been processed, as indicated in the step F8.

In practice, the server manages the steps F2 to F7 relating to each terminal in multitasking mode so as to update instantaneously the variables cited above. Consequently, sets of steps F2 to F7 are executed in parallel and asynchronously by the server SR.

In a more complete embodiment, the administrator terminal TA selects a plurality of processes to be applied to all of the files or a plurality of respective processes to be applied to each file. In this embodiment, the administrator terminal TA associates one or more respective processing identifiers with each participant terminal Tn and one or more respective processing identifiers with each selected file FT to be processed. A processing identifier associated with a file may depend on a sender address of the file. The central unit UC may initially assign average processing speeds to the selected processing identifiers in the step F1.

For each participant terminal Tn, the updating module MA in the server SR updates each processing speed relating to the processing designated by a file processing identifier associated with the terminal Tn as a function of the processing times of the files that are processed by the terminal Tn and associated with the processing identifier. The updating module MA then updates the processing speed of each terminal Tn as a function of the updated average of the processing speeds relating to the processing designated by the file processing identifiers associated with the terminal Tn so that the speeds of the terminals are taken into account in the dynamic distribution of the files between the terminals as a function of the type of processing to be applied to the files. Each processing speed average associated with a processing identifier is updated by the module MA as a function of processing speed of each file that has undergone the processing designated by the processing identifier and forwarded after processing to the server SR by a terminal associated with the processing identifier, as in step F4, but in relation to the terminals associated with the processing identifier.

Alternatively, the files comprise sub-files to be processed individually and the method of the invention is applied to the sub-files of the files. The sub-files may come from different senders having different addresses. Consequently, a participant terminal Tn is liable to process only sub-files coming from one or more predetermined senders having particular addresses. As previously for files, the participant terminal Tn is liable to apply one or more forms of processing to the sub-files.

For example, the sub-files are successive text portions. Two successive text portions of a text file may come from senders in the form of a voice recognition engine and a voice server, and take the following form: “I wish to dine in an Italian restaurant” and “You are looking for an Italian restaurant. I have found more than ten of them. Please give more details, for example a location, and consult the answers, or repeat your search”. The processing of these sub-files entails translation into a predetermined language and associating them with icons, for example.

The invention is not limited to the embodiments described above and variants thereof.

The invention described here relates to a method and a system for dynamically distributing files to be processed between participant terminals. In a preferred embodiment, the steps of the method are determined by the instructions of a program incorporated in the distribution server SR for dynamically distributing files to be processed between participant terminals connected to the distribution server. The method of the invention is used when that program is loaded into the distribution server SR or any other computer or data processing system whose operation is then controlled by executing the program.

Consequently, the invention applies equally to a computer program adapted to implement the invention, in particular a computer program performed by the distribution server SR and included in an information medium. The program may be written in any programming language and take the form of executable code or any other form suitable for implementing the method of the invention.

The information medium may be any entity or device capable of storing the program. For example, the medium may comprise storage means, such as a ROM, for example a CD-ROM or a microelectronic circuit ROM, or magnetic storage means, for example a diskette (floppy disk) or hard disk.

Furthermore, the information medium may be a transmissible medium such as an electrical or optical signal, which may be routed via an electrical or optical cable, by radio or by other means. The program of the invention may in particular be downloaded over an Internet type network.

Alternatively, the information medium may be an integrated circuit into which the program is incorporated, the circuit being adapted to execute the method of the invention or to be used in the execution of the method of the invention.

What we claim is:

1. A method of dynamically distributing files to be processed between participants using respective terminals connected to server means, said method including the following steps in said server means:
in response to a processed file transmitted by a terminal, updating a participant processing speed of each terminal as a function of a processing time of said processed file by said participant of said terminal evaluated from a transmission time of said processed file from said server means to said terminal,
updating an average of the participant processing speeds of said terminals as a function of said updated participant processing speeds of said terminals,
decrementing a number of remaining files to be processed in response to each processed file transmitted by a terminal,
updating a number of files assigned to each terminal as a function of said number of remaining files to be processed, said updated participant processing speed of said terminal and the updated average said participant processing speeds of said terminals, and
transmitting the updated number of assigned files and a remaining file to be processed to each terminal.

2. A method according to claim 1, further comprising the following steps:
associating respective processing identifiers with said files,
associating respective processing identifiers with said terminals,
updating for each terminal a participant processing speed relating to the processing designated by a file processing identifier associated with the terminal as a function of said processing times of said files processed by said participant of said terminal and associated with said processing identifier, and
updating said participant processing speed of each terminal as a function of said updated average of said participant processing speeds relating to the processing designated by said file processing identifiers associated with said terminal.

3. The method according to claim 2, wherein said processing identifier associated with a file depends on a sender address of said file.

4. The method according to claim 2, wherein a file is associated with a plurality of processing identifiers.

5. The method according to claim 2, wherein a terminal is associated with a plurality of processing identifiers.

6. The method according to claim 1, wherein a file comprises sub-files to be processed individually.

7. A system for dynamically distributing files to be processed between participants using respective terminals connected to server means, said server means including:
means for updating, in response to a processed file transmitted by a terminal, a participant processing speed of each terminal as a function of a processing time of said file processed by said participant of said terminal evaluated from the time of transmitting said processed file from said server means to said terminal,
means for updating an average of the participant processing speeds of the terminals as a function of said updated participant processing speeds of said terminals,
means for decrementing a number of remaining files to be processed in response to each processed file transmitted by a terminal,
means for updating a number of files assigned to each terminal as a function of said number of remaining files to be processed, said updated participant processing speed of said terminal and the updated average of said participant processing speeds of said terminals, and
means for transmitting the updated number of assigned files and a file remaining to be processed to each terminal.

8. A computer program adapted to be implemented in a system for dynamically distributing files to be processed between participants using respective terminals connected to server means, said computer program including instructions which, when said computer program is loaded into and executed in said server means, performs the following steps in said server means:
in response to a processed file transmitted by a terminal, updating a participant processing speed of each terminal as a function of a processing time of said processed file by said participant of said terminal evaluated from a transmission time of said processed file from said server means to said terminal,
updating an average of the participant processing speeds of said terminals as a function of said updated participant processing speeds of said terminals,
decrementing a number of remaining files to be processed in response to each processed file transmitted by a terminal,
updating a number of files assigned to each terminal as a function of said number of remaining files to be processed, said updated participant processing speed of said terminal and the updated average said participant processing speeds of said terminals, and
transmitting the updated number of assigned files and a remaining file to be processed to each terminal.
